(19) United States
(12) Patent Application Publication
(10) Pub. No.: US 2016/0075581 A1
(43) Pub. Date: Mar. 17, 2016

(54) METHOD AND INSTALLATION FOR TREATING WATER COMING FROM THE PETROLEUM AND GAS INDUSTRIES, ESPECIALLY PRODUCTION WATER FROM PETROLEUM AND/OR GAS FIELDS

(71) Applicant: VEOLIA WATER SOLUTIONS & TECHNOLOGIES SUPPORT, Saint-Maurice Cedex (FR)

(72) Inventors: Mouloud HENDOU, Prunay en Yveline (FR); Camille SAGNE, Issy Les Moulineaux (FR)

(73) Assignee: Veolia Water Solutions & Technologies Support, Saint-Maurice Cedex (FR)

(21) Appl. No.: 14/783,465

(22) PCT Filed: Apr. 4, 2014
(86) PCT No.: PCT/EP2014/056770

§ 371 Date: Oct. 9, 2015

(30) Foreign Application Priority Data
Apr. 10, 2013 (FR) 1353216

(51) Int. Cl. C02F 9/00; C02F 1/28; C02F 1/38; C02F 1/44

(52) U.S. Cl. CPC C02F 9/00; C02F 1/441; C02F 1/283; C02F 1/285; C02F 1/38; C02F 2103/10

(57) ABSTRACT

Method for treating water from the oil and gas industries, especially production water from oil and/or gas fields, with a view to its re-utilization, comprising a step for filtering said water on reverse osmosis membranes comprising a step of adsorption of the organic matter contained in said water, said step of adsorption being planned upstream to said step of filtration and being implemented on at least one adsorbent resin chosen from the group constituted by the non-ionic cross-linked resins and the microporous carbon resins, and corresponding installation.

### FIELD OF THE INVENTION

The invention pertains to the field of the treatment of industrial effluents and more specifically to the field of the treatment of industrial waste water coming from the petroleum, gas and petrochemical industries, such as production installations of petroleum and/or gas fields or again refineries, with a view to the re-utilization of this water.

### PRIOR ART

The recycling of water from industrial effluents is a major problem to which a great deal of research has been devoted in this past decade.

This problem is particularly sensitive in the gas and petroleum industry where it is being sought, after treatment, to re-utilize the production water from the petroleum and gas fields and again the water used for the refining of petroleum products. Indeed, especially in sites for extracting petroleum or gas, water is often scarce and costly.

Such industrial water however has the special characteristic of being charged with organic matter. This organic matter can be constituted by the extracted product, namely gas or petroleum. This is the case especially for production water from petroleum or gas fields. It can also be constituted by reagents, or residues of these reagents, used for the treatment of such products—this is the case especially for industrial water coming from refineries.

Almost all the methods developed for this purpose today incorporate a step of reverse osmosis membrane filtration which tends to ensure the production of a permeate responding to the specifications of a water that can be re-utilized in industrial sites. However, the forms of organic matter contained in this industrial water are all sources of damage that necessitate frequent washing of the membranes.

The development of these methods is therefore limited today because of the reverse osmosis membranes which are highly sensitive to the presence of organic matter in the water to be treated. The presence of organic matter is a handicap in practice for the use of these membranes. It results in their frequent clogging and the reducing of their service life.

This clogging can be reversible in certain cases, provided that a periodical chemical cleansing of the membranes is performed. This gives rise to a consumption of chemical reagents that can become a serious obstacle to the use of these technologies. Even more seriously, this clogging can become irreversible and the membranes can become unusable. This is the case especially with effluents from refineries and production water from petroleum fields containing naphthalene which can react with the reverse osmosis membranes made of polyamide, this reaction leading to the total or partial destruction of the membranes.

Several solutions are being implemented today to protect reverse osmosis membranes. In particular, there is the known use of active carbon to eliminate organic matter by adsorption on this compound, but this method is limited to low flow rates of water and to low concentrations of organic matter in order to reduce the consumption of active carbon. The use of this method therefore is not recommended for the treatment of production water from the gas and petroleum industries.

There also exist known methods of reverse osmosis with high pH that that give the organic material low clogging characteristics. Such methods are described especially in the documents W02008073963, U.S. Pat. No. 5,925,255 and U.S. Pat. No. 6,537,456. However, their use entails an excessive consumption of reagents and substantial production of sludge especially for water of a high level of hardness and alkalinity. This is the case with production water from the petroleum and gas fields. Because of this, the use of these methods for distant sites becomes difficult and calls for special logistics for procuring supplies of reagents and for discharging wastes.

In short, the solutions currently offered have only a limited field of application in the processing of production water for the gas and petroleum industries and in no case offer the possibility of recovering the pollutants contained in the water to be treated as products.

### GOALS OF THE INVENTION

It is a goal of the present invention to propose an improved method for the treatment by reverse osmosis of production water from the gas and petroleum industries with a view to its re-utilization.

In particular, it is a goal of the present invention to present a method of this kind which, in certain embodiments, improves the rate of conversion of the reverse osmosis filtration units, i.e. increases the percentage of re-utilizable water, produced in the form of permeate by these units, relative to the water supplied to them while at the same time reducing the volumes of reverse osmosis concentrate.

It is yet another goal of the present invention to disclose a method of this kind which, in at least certain embodiments, increases the service life of the reverse osmosis membranes.

It is yet another goal of the present invention to describe a method of this kind which, in certain embodiments, reduces the frequency of washing of the reverse osmosis membranes and also provides economies in terms of washing reagents and reduces the costs of treatment of the fouled wash water.

It is yet another goal of the present invention to propose a method of this kind which, in at least certain embodiments, enables the pollutants to be recovered in the form of products.

It is yet another goal of the present invention to disclose an installation for the implementation of such a method.

### SUMMARY OF THE INVENTION

These different goals, or at least some of them, are achieved by means of the present invention which pertains to a method for treating water coming from the petroleum and gas industries, especially production water from petroleum and/or gas fields, with a view to its re-utilization, comprising a step for the filtration of said water on a reverse osmosis membrane, this method being characterized in that it comprises a step for adsorption of the organic matter contained in said water, said step of adsorption being planned upstream of said filtration step and being implemented on at least one adsorbent resin chosen from the group constituted by the non-ionic cross-linked polymeric resins and the microporous carbon resins which, by nature, are also non-ionic.

The present invention consists therefore of the use of non-ionic adsorbent resins (which excludes ion-exchange resins) taking the form of non-ionic cross-linked polymeric resins and/or microporous carbon resins for the protection of reverse osmosis membranes against the organic matter contained in industrial water coming from the petroleum, gas and petrochemical industries, especially production water from petroleum and gas fields.

The present invention enables operation at low or high flow rates of water to be treated, whatever the concentration of organic compounds harmful to the reverse osmosis membranes present in this water.

According to one variant, the method of the invention comprises a step of pre-treatment provided upstream to said step of adsorption of organic matter.

Such pre-treatment can advantageously consist of a simple physical preparation, a physical/chemical treatment, a biological treatment or again a more elaborate treatment combining two or all three of the treatments mentioned here above.

According to one embodiment of the method of the invention, a single adsorbent specific resin dedicated to the elimination of a target organic compound will be used.

According to other embodiments, said step of adsorption will be implemented on two or more adsorbent resins enabling the elimination of one or more organic compounds.

The choice of the adsorbent resin or resins will be done according to the nature and concentration in pollutants present in the effluents to be treated.

Preferably, the method according to the invention comprises a step of in-situ regeneration of said at least one adsorbent resin. Such a step of regeneration enables the re-utilization of the resins and their maintenance in an optimal operation state in terms of efficiency of elimination of organic matter and adsorption capacity.

Advantageously, said step of in-situ regeneration of said at least one adsorbent resin is achieved by a regeneration medium chosen from the group constituted by steam heated to a temperature of 120° C. to 200° C., preferably 120° C. to 150° C., a solvent with low boiling point, a base, an acid or by the combination of two or more of these regeneration media.

According to one variant, said regeneration medium is a solvent with a low boiling point such as an alcohol or a ketone, the method then comprising more than one subsequent step for recycling said solvent by evaporation leading to the obtaining of two phases: a condensed phase constituted by regenerated solvent capable of being re-utilized in a subsequent step of in-situ regeneration of said at least one adsorbent resin and an organic phase constituted by adsorbent organic matter.

According to another variant, said regeneration medium is steam, the method then additionally comprising a subsequent step of condensation of said steam leading to the obtaining of two phases: an aqueous phase constituted by water saturated in organic compounds and an organic phase constituted by adsorbent organic matter.

In this case, the method comprises, also preferably, a step for treating said aqueous phase constituted by water saturated in organic compounds consisting in making it pass over said at least one adsorbent resin so as to de-saturate it of organic compounds and leading to water capable of being re-utilized during a subsequent step of in-situ regeneration of said at least one adsorbent resin.

When said industrial water, treated by the method of the invention, is production water from petroleum fields and/or gas fields, said organic phase constituted by adsorbed organic matter obtained during the regeneration of the resin is constituted by petroleum and various forms of organic matter such as benzene, toluene, xylene, ethylbenzene and styrene which can thus be recovered. The invention then enables the recovery of the organic compounds as products, which was not possible in the prior art.

The present invention also pertains to any installation for the implementing of the method described here above, characterized in that it comprises:

means for conveying industrial water;

at least one reverse osmosis membrane filtration unit;

at least one column of adsorbent resins chosen from the group constituted by non-ionic cross-linked polymeric resins and microporous carbon resins;

means for discharging treated water;

said at least one column being provided upstream to said at least one reverse osmosis membrane filtration unit.

Advantageously, said installation comprises at least one pre-treatment unit provided upstream to said at least one column. This pre-treatment unit could be constituted by one or more modules implementing a physical separation such as for example one or more membrane ultrafiltration modules, by physical/chemical treatment means, by biological treatment means or again by more elaborate means of treatment combining two or all three of the above-mentioned treatments.

Advantageously, the installation according to the invention comprises means for regenerating said at least one resin by means of at least one regeneration medium chosen from the group constituted by steam heated to a temperature of 120° C. to 200° C., preferably 120° C. to 150° C., a solvent with a low boiling point, a base, an acid or a combination of two or more of these regeneration media.

When the regeneration medium is a solvent with a low boiling point, such as ethanol, the installation preferably comprises means for the recycling, by evaporation/condensation, of said solvent after it has passed over said at least one column.

When the regeneration medium is steam, the installation preferably comprises means for condensation of the steam after it has passed over said at least one column, means for conveying the thus aqueous phase obtained at the head of said column and means for recovering, at the base this column, water capable of being heated to give regeneration steam.

### DETAILED DESCRIPTION OF THREE EMBODIMENTS OF THE INVENTION

The invention as well as its different advantages shall be understood more clearly from the following description of three embodiments according to this invention, given on an illustratory and non-exhaustive basis.

In the first embodiment, two types of distinct resins have been implemented, namely a non-ionic cross-linked polymer resin and a carbon resin.

In the second embodiment, only one non-ionic cross-linked polymer resin has been implemented.

In the third embodiment, only one carbon resin has been implemented.

### First Embodiment

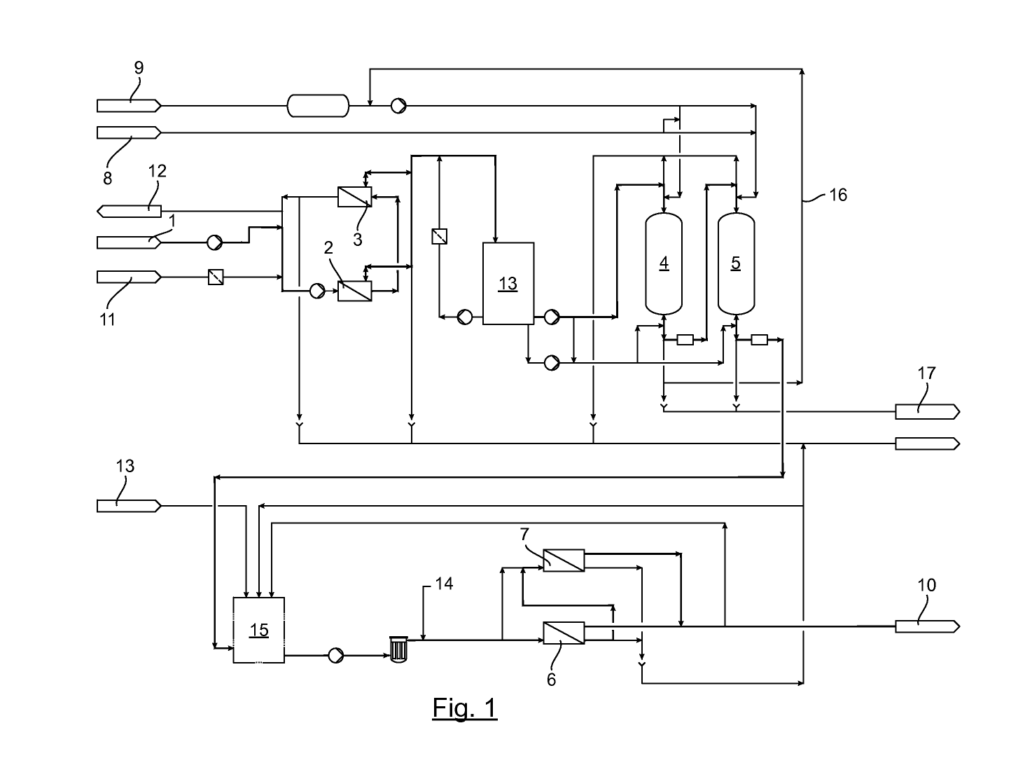

This first embodiment is described with reference to FIG. 1 which represents the schematic view of a pilot installation implementing a method according to the invention for the treatment of production water from petroleum fields with a view to its re-utilization.

The pilot installation comprises means 1 for the conveying polluted water to be treated to a unit of pre-treatment by ultrafiltration implementing two cascade-mounted ultrafiltration membrane modules 2.3. This pre-treatment unit eliminates matter in suspension matter and free oils contained in the effluents. The pilot installation includes means 11 for conveying and means 12 for discharging a solution of reagent for the in-situ washing of the ultrafiltration membranes.

After this pre-treatment, the pre-treated effluents are directed, in the example, towards an optional buffer tank 13 and then directed towards two series-mounted columns 4.5 containing two specific resins.

The first column 4 contains a commercially available non-ionic cross-linked polymer resin (resin 1) selected for its capacity to adsorb aromatic components such as BTEX (benzene, toluene, ethylbenzene, xylene) and the polycyclic compounds such as HAP (example: naphthalene). The characteristics of this resin are given in the Table 1 here below:

TABLE 1
Physical and chemical properties

| | |
|---|---|
| Ionic form | neutral |
| Functional groups | none |
| Matrix | Cross-linked polystyrene |
| Structure | Porous beads |
| Coefficient of uniformity | 1.1 max |
| Mean size of beads | 0.44 to 0.54 mm |
| Bulk density | 600 g/l |
| Water retention capacity | 600 g/kg resin +/−5% |
| Specific surface area (BET method) | About 800 m²/g approximately |
| Volume of pores | 1.2 cm³/g approximately |
| Average diameter of pores | 5 to 10 nm |
| pH stability | 0 to 14 |
| Temperature stability | −20° C. to 120° C. |

The second column 5 contains a microporous carbon resin (resin 2), also commercially available, selected for its ability to fix compounds in trace states more advantageously. The characteristics of this resin are liven in the Table 2 here below:

TABLE 2

| Physical and chemical properties | |
|---|---|
| Ionic form | neutral |
| Functional groups | none |
| Matrix | carbon |
| Grain size | 0.4 to 0.8 mm (>90%) |
| Bulk density | 550 to 650 g/l +/−5% |
| Specific surface area (BET method) | About 1200 m²/g |
| Volume of pores | About 0.15 cm³/g |
| Average diameter of pores | 8 nm |
| Temperature stability | −20° C. to 300° C. |

The pilot installation comprises means for the regeneration 8, 9 of the resins, either by steam 8 or by a solvent 9.

When the regeneration is done by means of a solvent, the solvent charged with organic matter can be recovered at the exit from the columns so as to undergo evaporation leading to the obtaining of two phases: a condensed phase constituted by regenerated solvent recycled by a pipe 16 and an organic phase constituted by organic matter capable of being discharged at 17.

When the regeneration is done with steam, the steam can be discharged at 17 at the exit from the columns and then condensed, the condensation leading to two phases being obtained: an aqueous phase constituted by water saturated with organic compounds and an organic phase constituted by adsorbed organic matter. The aqueous phase can then pass over a first column of adsorbent resin so as to de-saturate it of organic compounds, this operation leading to water capable of being re-utilized to make steam in a subsequent stage of in-situ regeneration of these resins.

Downstream to the resin columns 4, 5, a reverse osmosis membrane filtration unit comprising two stages 6, 7 is planned. This unit can be implemented either with two stages to increase the rate of conversion or with two runs to better refine the osmosis permeate. This osmosis permeate constituted by water of a quality enabling its re-utilization is discharged by a pipe 10.

The pilot installation includes means for conveying 13 and means for discharging a chemical solution for the in-situ washing of the reverse osmosis membranes (these discharge means correspond to the discharge means 12 of the solution for in-situ washing of the ultrafiltration membranes used for the pre-treatment). The cleaning solution is sent, according to this example, into the buffer tank 15. This solution can also be sent directly in the conduit for conveying the effluents treated on resin. Means 14 for injecting a confining product aimed at limiting scaling of the membranes are also planned upstream to these membranes.

Regeneration tests were carried out using steam and a solvent with a low boiling point, in this case ethanol. It can be noted that it is possible to use only one of these two regeneration media or both of them.

The characteristics of the production water from a petroleum field treated by means of the installation described here above are explained in the Table 3 here below.

TABLE 3

| Parameters | Unit | Range of values |
|---|---|---|
| pH | upH | 6.5-7.5 |
| Chloride | mg/L | 2500-5000 |
| Sulfate | mg/L | 500-2000 |
| Alkalinity | ppm CaCO₃ | 500-2000 |
| Sodium | mg/L | 1500 3500 |
| Calcium | mg/L | 200-2000 |
| Magnesium | mg/L | 50-300 |
| Dissolved salts | mg/L | 5000-10000 |
| Benzene | mg/L | 1-30 |
| Toluene | mg/L | 1-30 |
| Ethylbenzene | mg/L | 1-10 |
| Xylene | mg/L | 1-5 |
| Phenol | mg/L | 1-30 |
| Naphtalene | mg/L | 0.5-5 |
| Benzyl alcohol | mg/L | 5-30 |
| 2-methylphenol | mg/L | 1-5 |
| 3-methylphenol | mg/L | 1-5 |
| 4-methylphenol | mg/L | 1-5 |
| TOC | mg/L | 20-150 |

The trials were conducted without the use of resins, in bypassing them (circuit not shown in the figure), and with the use of resins. This yielded the following information.

The treatment without resin showed a clogging of the membranes at the end of one month of service characterized by a 20% loss of flow rate of permeate passing through the reverse osmosis membranes at constant pressure or again a 15% increase in pressure at a constant flow rate of permeate. For treatment with resins, this phenomenon was observed only after three months of operation. This confirms the positive effect on the resins of the frequency of cleaning of the membranes.

In terms of conversion rate (flow rate of permeate produced/flow rate of supply) of the reverse osmosis unit without use of resins, the conversion rate was limited to 67%. The use of resins increased this figure to 83% without any negative effect on the structures of the reverse osmosis membranes.

In terms of performance of treatment, ultrafiltration reduced the concentration of oils and matter in suspension to levels below 1 mg/L. The resins for their part gave the levels of reduction collated in the following Table 4.

TABLE 4

| | Resin 1 | Resin 2 |
|---|---|---|
| | (polymer) | (carbon) |
| | (%) | (%) |
| Benzene | 99.5 ± 0.5 | 99.9 ± 0.1 |
| Toluene | 99.5 ± 0.5 | 99.9 ± 0.1 |
| Ethylbenzene | 99.5 ± 0.5 | 99.8 ± 0.1 |
| Xylene | 99.5 ± 0.5 | 99.8 ± 0.1 |
| Phenol | 96.5 ± 0.5 | 99.9 ± 0.1 |
| Naphtalene | 99.7 ± 0.3 | 99.9 ± 0.1 |
| Benzyl alcohol | 84.0 ± 1.0 | 99.5 ± 0.5 |
| 2-methylphenol | 99.5 ± 0.5 | 99.9 ± 0.1 |
| 3-methylphenol | 99.5 ± 0.5 | 99.9 ± 0.1 |
| 4-methylphenol | 99.5 ± 0.5 | 99.9 ± 0.1 |
| TOC | 50.0 ± 5.0 | 85.0 ± 5.0 |

In terms of regeneration capacity, the resins were regenerated by steam. This regeneration made it possible to recover up to 80% of the adsorption capacities of the resins. This means that the production cycle for fresh resins is greater than that of used resins by 20%. Furthermore, the condensation of steam made it possible to separate the organic matter adsorbed on the first resin. The conditions and results of this regeneration are indicated in the following Table 5.

TABLE 5

| | Resin 1 | Resin 2 |
|---|---|---|
| | (polymer) | (carbon) |
| | (%) | (%) |
| Benzene | 99.5 ± 0.5 | 99.9 ± 0.1 |
| Toluene | 99.5 ± 0.5 | 99.9 ± 0.1 |
| Ethylbenzene | 99.5 ± 0.5 | 99.8 ± 0.1 |
| Xylene | 99.5 ± 0.5 | 99.8 ± 0.1 |
| Phenol | 96.5 ± 0.5 | 99.9 ± 0.1 |
| Naphtalene | 99.7 ± 0.3 | 99.9 ± 0.1 |
| Benzyl alcohol | 84.0 ± 1.0 | 99.5 ± 0.5 |
| 2-methylphenol | 99.5 ± 0.5 | 99.9 ± 0.1 |
| 3-methylphenol | 99.5 ± 0.5 | 99.9 ± 0.1 |
| 4-methylphenol | 99.5 ± 0.5 | 99.9 ± 0.1 |
| TOC | 50.0 ± 5.0 | 85.0 ± 5.0 |

Regeneration with ethanol gave the same performance as that of steam, in terms of recovery of adsorption capacities and organic matter content capable of being valorized after evaporation and recovery of ethanol.

The mode of regeneration combining steam as a utility of regeneration and ethanol, one in every ten regeneration cycles, showed better performance in terms of rate of recovery of capacity of adsorption of resins because this capacity is increased and reaches 95%.

### Second Embodiment

The installation used in the context of the second embodiment is the same as the one described with reference to FIG. 1 with the modification according to which the column containing carbon resin was bypassed, the effluent travelling only in the column containing non-ionic polymer resin.

Phenolated water coming from a petrochemical industrial unit was treated in this installation, reducing the concentration of phenol by 92%, i.e. from 450 mg/l to 36 mg/l.

### Third Embodiment

The installation used in the third embodiment is the same as the one described with reference to FIG. 1 with the modification whereby the column containing polymer resin was bypassed, the effluent travelling only in the column containing carbon resin.

Petrochemical effluents coming from a cellulose acetate production unit containing diisopropyl ether were treated in this installation, reducing the concentration of this substance from 300 mg/l to 40 mg/l.

1-16. (canceled)

17. A method for treating water from the oil and gas industries including produced water from oil and/or gas fields, with a view to reutilizing the water, comprising:
filtering said water with reverse osmosis membranes; and
characterized in that the method comprises adsorbing organic matter contained in said water upstream of filtering the water with reverse osmosis membranes and being implemented on at least one adsorbent resin chosen from the group consisting of non-ionic cross-linked resins and microporous carbon resins.

18. The method of claim 17 further including pre-treating said water upstream of adsorbing the organic matter from the water.

19. The method of claim 18 wherein the pre-treatment comprises a physical separation process, a physical-chemical process, or a biological treatment process or a combination of two or all three of said pre-treatment processes.

20. The method of claim 17 wherein adsorbing the organic matter comprises utilizing a specific adsorbent resin that is effective to eliminates a target organic compound.

21. The method of claim 17 wherein adsorbing the organic matter includes utilizing two or more adsorbent resins the enable the elimination of one or more organic compounds.

22. The method of claim 17 comprising in-situ regeneration of said at least one adsorbent resin.

23. The method of claim 22 wherein of the in-situ regeneration of said at least one adsorbent resin is achieved by a regeneration medium that includes steam heated to a temperature of 120° C. to 200° C., a solvent, a base, an acid or by a combination of two or more of said media.

24. The method of claim 23 wherein said regeneration medium is a solvent comprising alcohol and the method includes recycling the solvent by evaporating the solvent to produce a condensed phase that can be re-utilized during a subsequent step of in-situ regeneration and an organic phase comprising adsorbed organic matter.

25. The method of claim 23 wherein said regeneration medium is steam and the method includes condensing said steam to produce two phases, an aqueous phase comprising water saturated with organic compounds and an organic phase comprising adsorbed organic matter.

26. The method of claim 25 including treating the aqueous phase comprised of water saturated with organic compounds by passing the aqueous phase over a second adsorbent resin so as to desaturate the aqueous phase of organic compounds and resulting in water capable of being re-utilized during a subsequent step of in-situ regeneration of said at least one adsorbent resin.

27. A system for treating produced water separated from oil or gas in an oil or gas recovery process, the system for treating produced water comprising:
a pre-treatment unit for pre-treating the produced water and removing suspended solids and free oil from the produced water;
first and second columns connected in series and disposed downstream of the pre-treatment unit for receiving produced water and permitting produced water to pass therethrough in order to remove organic compounds from the produced water;
said first column comprising a cross-linked non-ionic polymer resin that adsorbs aromatic compounds and polycyclic compounds from the produced water as the produced water moves through said first column;
said second column comprising a microporous carbon resin for treating the produced water;
a resin regeneration unit operatively associated with both said first and second columns for regenerating the resins therein; and
a reverse osmosis unit disposed downstream of the first and second columns for removing dissolved solids from the produced water after the produced water has been treated in said first and second columns.

28. The system of claim 27 wherein said resin regeneration unit includes one regeneration medium chosen from the group consisting of steam heated to a temperature of 120° C. to 200° C. and a solvent.
